(19) United States
(12) Patent Application Publication
(10) Pub. No.: US 2011/0296352 A1
(43) Pub. Date: Dec. 1, 2011

(54) ACTIVE CALIBRATION OF A NATURAL USER INTERFACE

(75) Inventor: Kenneth A. Lobb, Sammamish, WA (US)

(73) Assignee: MICROSOFT CORPORATION, Redmond, WA (US)

(21) Appl. No.: 12/788,731

(22) Filed: May 27, 2010

(51) Int. Cl. G06F 3/033; G06F 3/048

(52) U.S. Cl. 715/848; 715/863; 715/856

(57) ABSTRACT

A system and method are disclosed for periodically calibrating a user interface in a NUI system by performing periodic active calibration events. The system includes a capture device for capturing position data relating to objects in a field of view of the capture device, a display and a computing environment for receiving image data from the capture device and for running applications. The system further includes a user interface controlled by the computing environment and operating in part by mapping a position of a pointing object to a position of an object displayed on the display. The computing environment periodically recalibrates the mapping of the user interface while the computing environment is running an application.

### BACKGROUND

In the past, computing applications such as computer games and multimedia applications used controllers, remotes, keyboards, mice, or the like to allow users to manipulate game characters or other aspects of an application. More recently, computer games and multimedia applications have begun employing cameras and software gesture recognition engines to provide a natural user interface (“NUI”). With NUI, user gestures are detected, interpreted and used to control game characters or other aspects of an application.

When using a mouse or other integrated controller, only minor initial calibration is necessary. However, in a NUI system, the interface is controlled by a user's position in, and perception of, the 3-D space in which they move. Thus, many gaming and other NUI applications have an initial calibration process which correlates the user's 3-D real world movements to the 2-D screen space. In the initial calibration process, a user may be prompted to point at an object appearing at a screen boundary, and the user's movements to complete this action is noted and used for calibration. However, over a gaming or other session, a user may tire, become excited or otherwise alter the movements with which the user interacts with the system. In such instances, the system will no longer properly register movements that initially affected a desired interaction with the system.

### SUMMARY

Disclosed herein are systems and methods for periodically calibrating a user interface in a NUI system by performing periodic active calibration events. The system includes a capture device for capturing position data relating to objects in a field of view of the capture device, a display and a computing environment for receiving image data from the capture device and for running applications. The system further includes a user interface controlled by the computing environment and operating by mapping a 3-D position of a pointing object to a 2-D position on the display. In embodiments, the computing environment periodically recalibrates the mapping of the user interface while the computing environment is running an application.

In a further embodiment, the present technology relates to a method of active calibration of a user interface for a user to interact with objects on a display. The method includes the steps of running an application on a computing environment; receiving input for interacting with the application via the user interface; periodically performing an active calibration of the user interface while running the application; and recalibrating the user interface based at least in part on the performed active calibration.

In a further embodiment, the present technology relates to a method of active calibration of a user interface for a user to interact with objects on a display, including the steps of providing the user interface, the user interface mapping a position of a user interface pointer in 3-D space to a 2-D position on the display; displaying a target object on the display; detecting an attempt to select the target object on the display via the user interface and user interface pointer; measuring a 3-D position of the user interface pointer in selecting the target object; determining a 2-D screen position corresponding to the user's measured position; determining a disparity between the determined 2-D screen position and the 2-D screen position of the target object; and periodically repeating the above steps.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A illustrates an example embodiment of a target recognition, analysis, and tracking system.

FIG. 1B illustrates a further example embodiment of a target recognition, analysis, and tracking system.

FIG. 2 illustrates an example embodiment of a capture device that may be used in a target recognition, analysis, and tracking system.

FIG. 3A illustrates an example embodiment of a computing environment that may be used to interpret one or more gestures in a target recognition, analysis, and tracking system.

FIG. 3B illustrates another example embodiment of a computing environment that may be used to interpret one or more gestures in a target recognition, analysis, and tracking system.

FIG. 4 illustrates a skeletal mapping of a user that has been generated from the target recognition, analysis, and tracking system of FIGS. 1A-2.

FIG. 5 is a flowchart of the operation of an embodiment of the present technology.

FIG. 6 is a flowchart of additional detail of an active calibration event step of FIG. 5.

FIG. 7 is a flowchart of additional detail of a recalibration of the user interface of FIG. 5.

FIG. 8 illustrates an example of a user interacting with a target recognition, analysis, and tracking system of the present technology.

FIG. 9 illustrates a first active calibration event presented to a user while interacting with the target recognition, analysis, and tracking system.

FIG. 10 illustrates a second active calibration event presented to a user while interacting with the target recognition, analysis, and tracking system.

FIG. 11 illustrates a third active calibration event presented to a user while interacting with the target recognition, analysis, and tracking system.

FIG. 12 illustrates a fourth active calibration event presented to a user while interacting with the target recognition, analysis, and tracking system.

### DETAILED DESCRIPTION

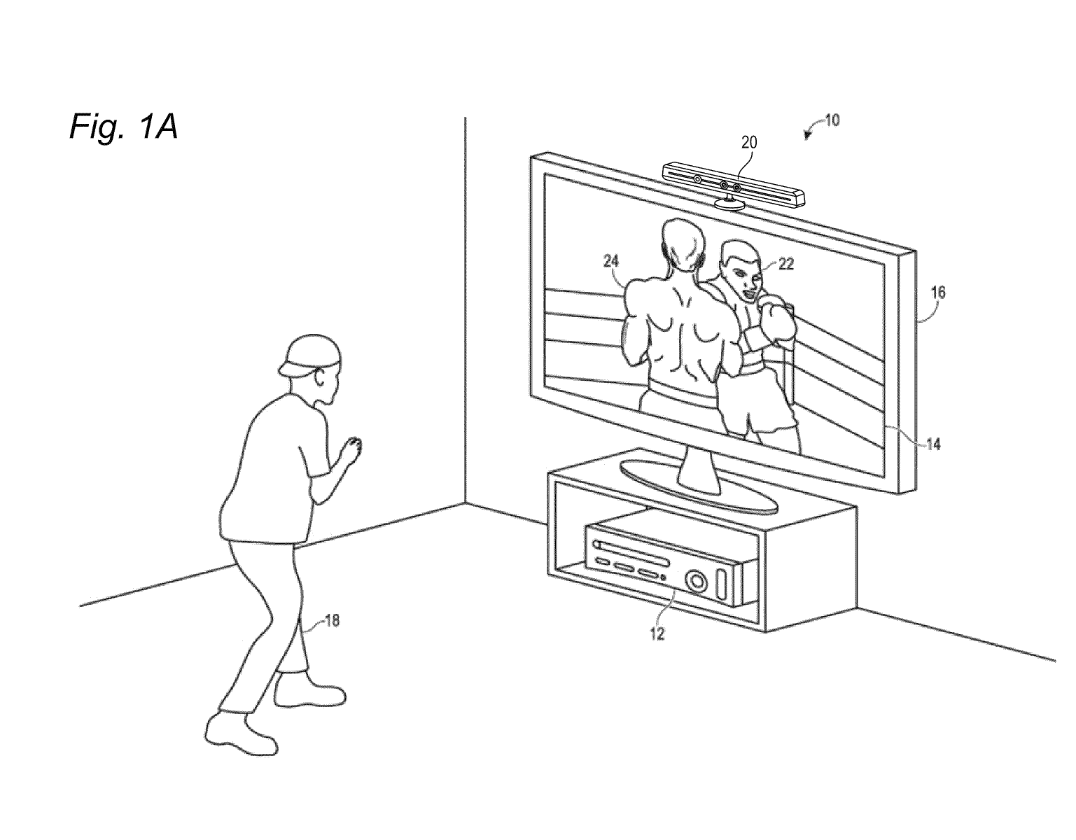

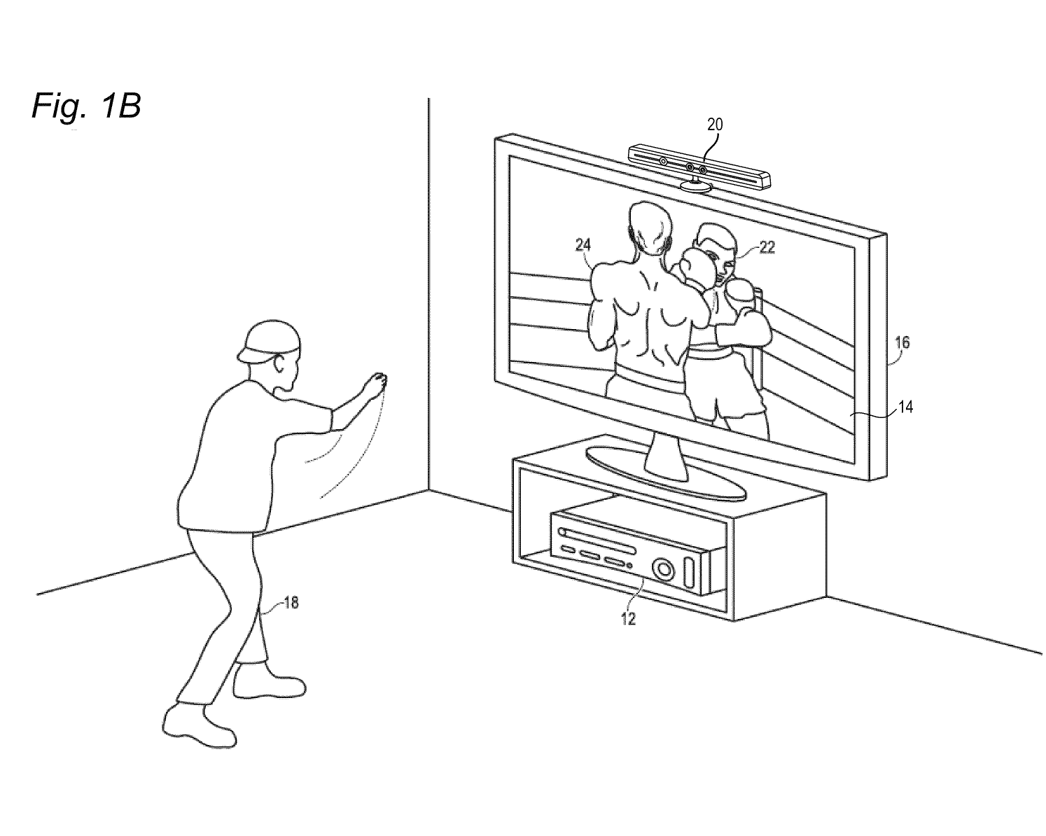

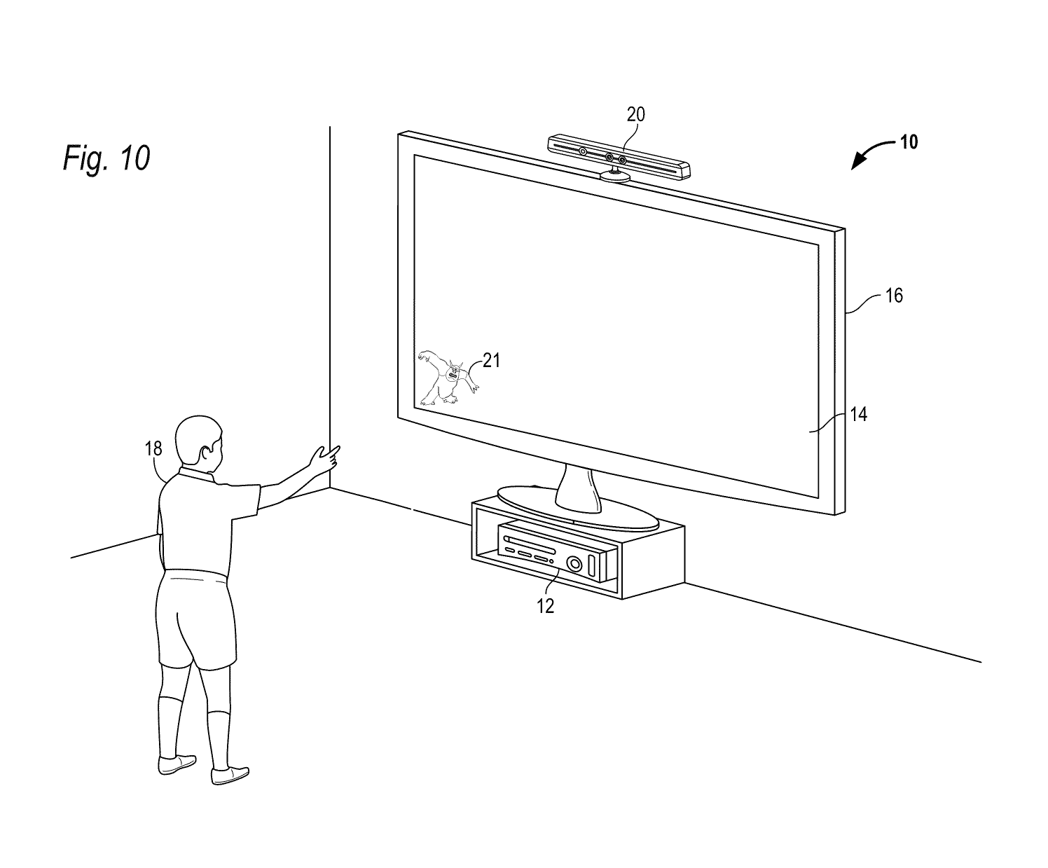

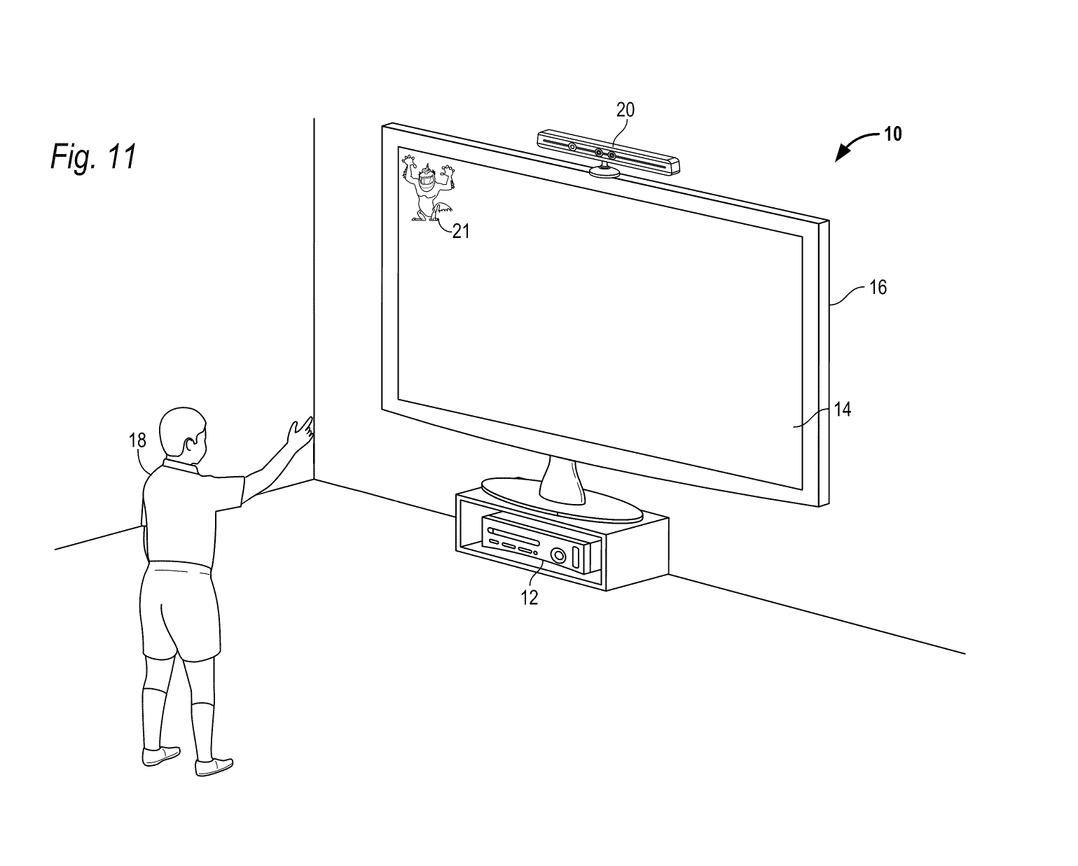

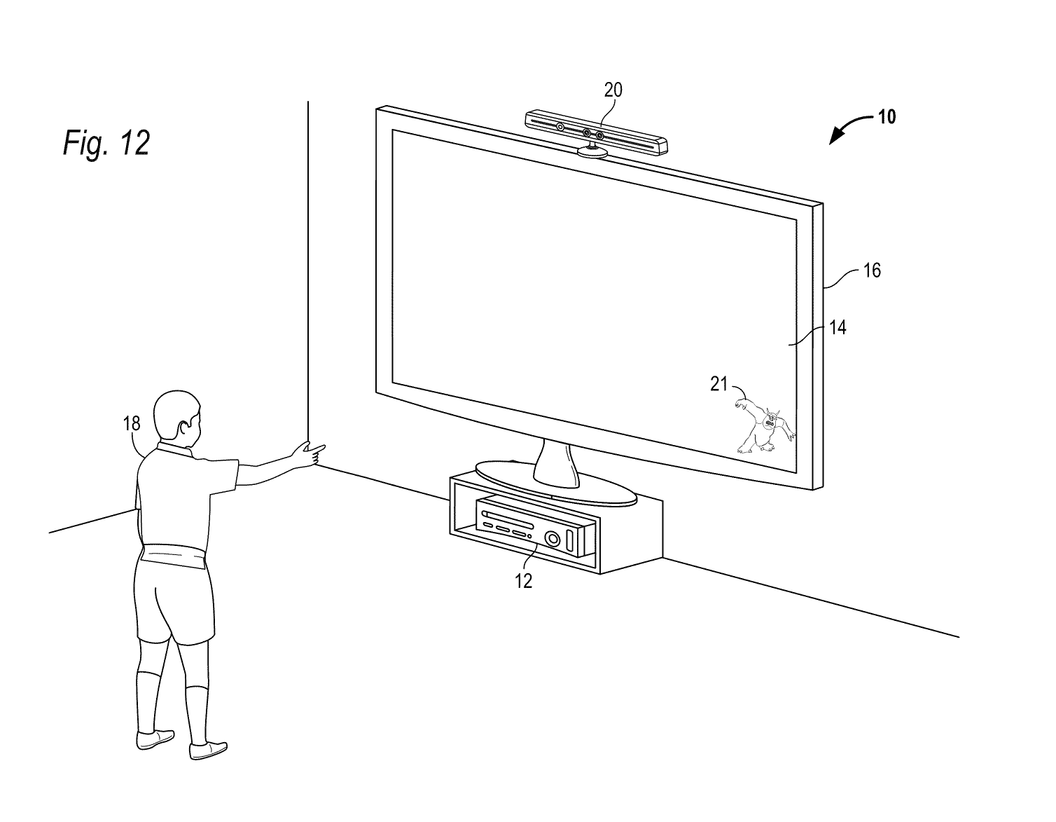

Embodiments of the present technology will now be described with reference to FIGS. 1A-12, which in general relate to a system for active calibration of a NUI. In embodiments, the active calibration may take place within a gaming or other NUI application. During interaction with the application, the user is prompted to interact with a virtual target object displayed on the screen. Generally, the target object may be at a border of the screen, but need not be in further embodiments. The system senses the position of the user when attempting to interact with the target object. This information is used, either by itself or in conjunction with previous active calibration events, to determine what interactions the user is intending to perform within a NUI application.

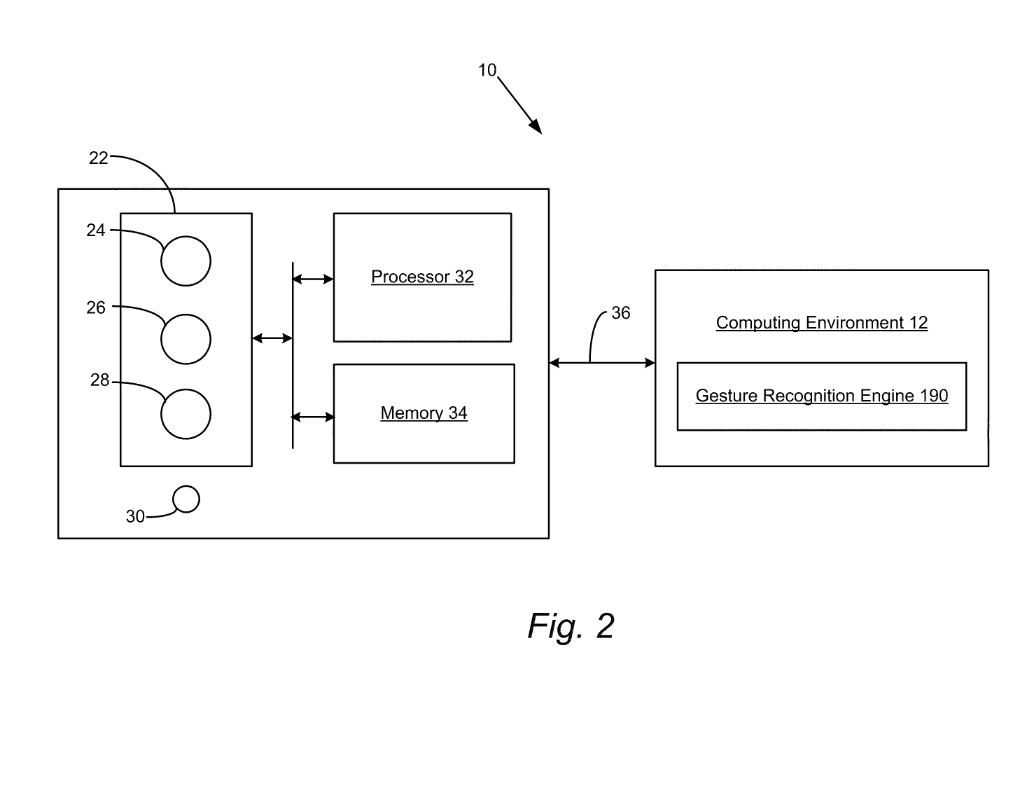

Referring initially to FIGS. 1A-2, the hardware for implementing the present technology includes a target recognition, analysis, and tracking system 10 which may be used to recognize, analyze, and/or track a human target such as the user 18. Embodiments of the target recognition, analysis, and tracking system 10 include a computing environment 12 for executing a gaming or other NUI application, and an audiovisual device 16 for providing audio and visual representations from the gaming or other application on a display 14. The system 10 further includes a capture device 20 for detecting gestures of a user captured by the device 20, which the computing environment receives and uses to control the gaming or other application. The computing environment controls a user interface, where a user and/or other objects in the field of view of the capture device are used to control and interact with onscreen objects. In one aspect of operation, the user interface maps a position of a 3-D object in the field of view of the capture device to a 2-D position on the display. Each of these components is explained in greater detail below.

As shown in FIGS. 1A and 1B, in an example embodiment, the application executing on the computing environment 12 may be a boxing game that the user 18 may be playing. For example, the computing environment 12 may use the audiovisual device to provide a visual representation of a boxing opponent 22 to the user 18. The computing environment 12 may also use the display 14 to provide a visual representation of a player avatar 24 that the user 18 may control with his or her movements. For example, as shown in FIG. 1B, the user 18 may throw a punch in physical space to cause the player avatar 24 to throw a punch in game space. Thus, according to an example embodiment, the computer environment 12 and the capture device 20 of the target recognition, analysis, and tracking system 10 may be used to recognize and analyze the punch of the user 18 in physical space such that the punch may be interpreted as a game control of the player avatar 24 in game space.

Other movements by the user 18 may also be interpreted as other controls or actions, such as controls to bob, weave, shuffle, block, jab, or throw a variety of different power punches. The embodiment of FIGS. 1A and 1B is one of many different applications which may be run on computing environment 12 in accordance with the present technology. The application running on computing environment 12 may be a variety of other gaming applications. Moreover, the application may be a NUI interface, allowing a user to scroll through a variety of menu options presented on the display 14. As explained above, any of the above applications may periodically present a calibration event, provided for the system to calibrate the user's movements with the onscreen activity. The calibrations events and their affect are explained below.

FIG. 2 illustrates an example embodiment of the capture device 20 that may be used in the target recognition, analysis, and tracking system 10. Further details relating to a capture device for use with the present technology are set forth in copending patent application Ser. No. 12/475,308, entitled “Device For Identifying And Tracking Multiple Humans Over Time,” which application is incorporated herein by reference in its entirety. However, in an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a length in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

According to another embodiment, the capture device 20 may include two or more physically separated cameras that may view a scene from different angles, to obtain visual stereo data that may be resolved to generate depth information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. A variety of known techniques exist for determining whether a target or object detected by capture device 20 corresponds to a human target. Skeletal mapping techniques may then be used to determine various spots on that user's skeleton, joints of the hands, wrists, elbows, knees, nose, ankles, shoulders, and where the pelvis meets the spine. Other techniques include transforming the image into a body model representation of the person and transforming the image into a mesh model representation of the person.

The skeletal model may then be provided to the computing environment 12 such that the computing environment may perform a variety of actions. In accordance with the present technology, the computing environment 12 may use the skeletal model to determine the calories being burned by the user. Although not pertinent to the present technology, the computing environment may further track the skeletal model and render an avatar associated with the skeletal model on the display 14. The computing environment may further determine which controls to perform in an application executing on the computer environment based on, for example, gestures of the user that have been recognized from the skeletal model. For example, as shown, in FIG. 2, the computing environment 12 may include a gesture recognizer engine 190 for determining when the user has performed a predefined gesture.

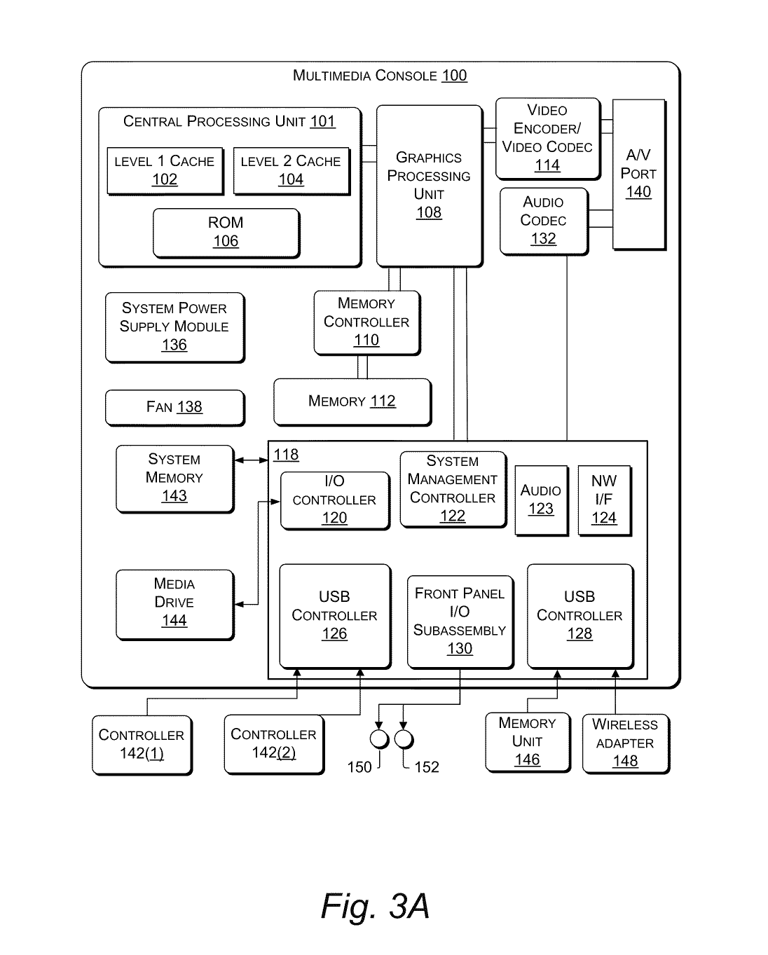

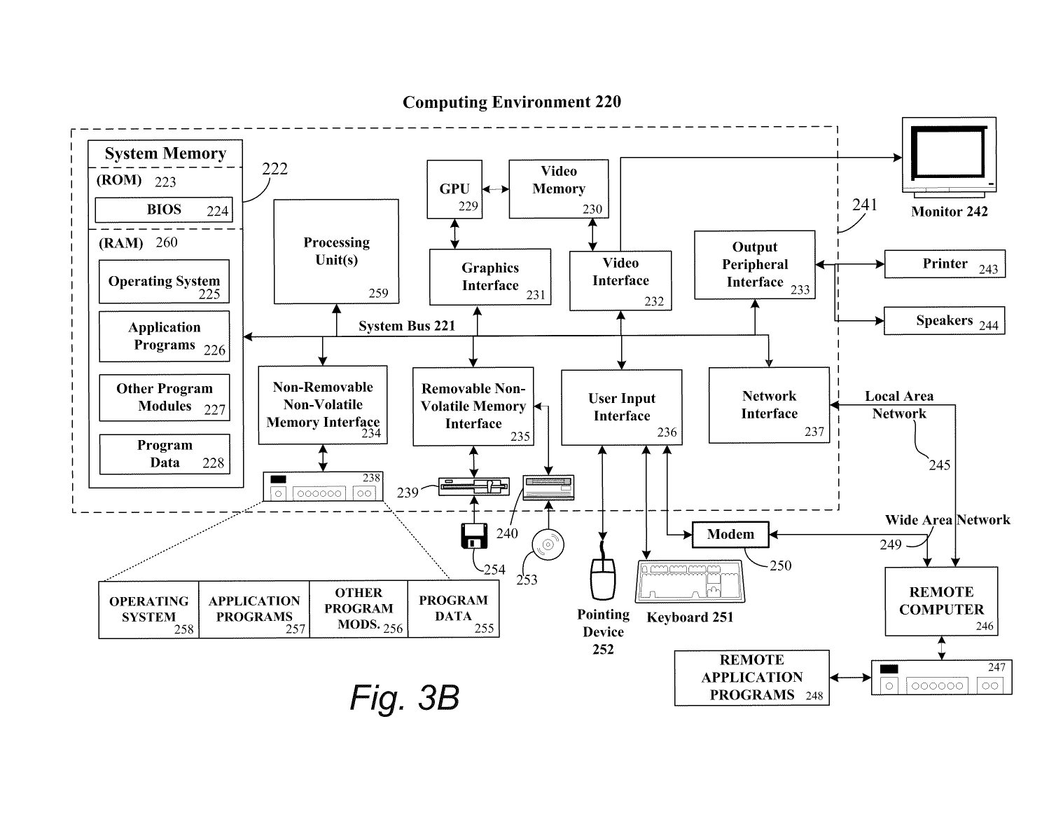

FIG. 3A illustrates an example embodiment of a computing environment that may be used to interpret one or more positions and motions of a user in a target recognition, analysis, and tracking system. The computing environment such as the computing environment 12 described above with respect to FIGS. 1A-2 may be a multimedia console 100, such as a gaming console. As shown in FIG. 3A, the multimedia console 100 has a central processing unit (CPU) 101 having a level 1 cache 102, a level 2 cache 104, and a flash ROM 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM.

The multimedia console 100 includes an I/O controller 120, a system management controller 122, an audio processing unit 123, a network interface controller 124, a first USB host controller 126, a second USB host controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 100.

FIG. 3B illustrates another example embodiment of a computing environment 220 that may be the computing environment 12 shown in FIGS. 1A-2 used to interpret one or more positions and motions in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 3B, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as ROM 223 and RAM 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 3B illustrates operating system 225, application programs 226, other program modules 227, and program data 228. FIG. 3B further includes a graphics processor unit (GPU) 229 having an associated video memory 230 for high speed and high resolution graphics processing and storage. The GPU 229 may be connected to the system bus 221 through a graphics interface 231.

The computer 241 may also include other removable/non-removable, volatile/nonvolatile computer storage media. By way of example only, FIG. 3B illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 3B, provide storage of computer readable instructions, data structures, program modules and other data for the computer 241. In FIG. 3B, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and a pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 3B. The logical connections depicted in FIG. 3B include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 3B illustrates remote application programs 248 as residing on memory device 247. It will be appreciated that the network connections shown are exemplary and other means of establishing a communications link between the computers may be used.

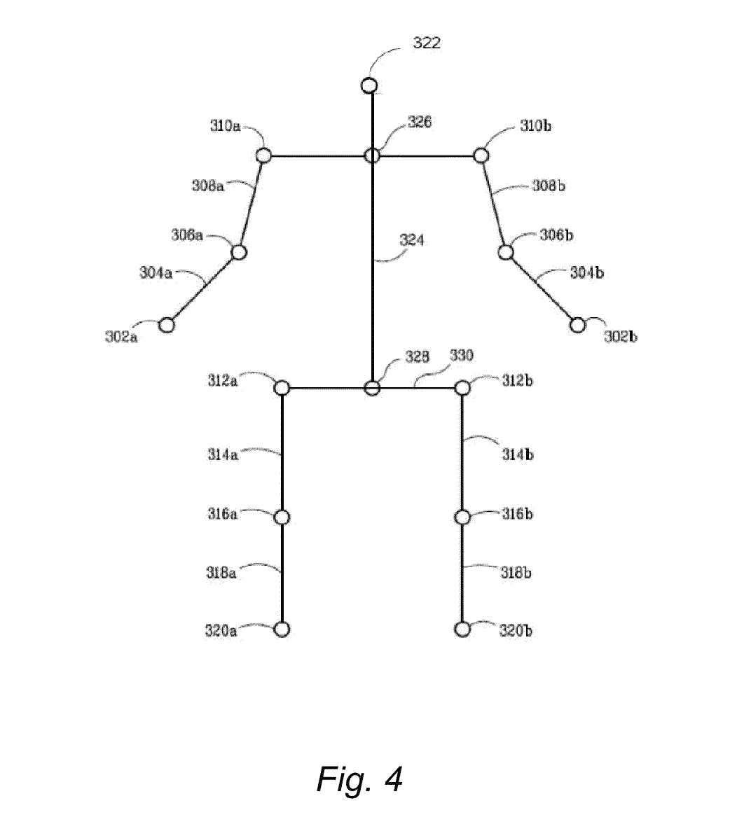

FIG. 4 depicts an example skeletal mapping of a user that may be generated from the capture device 20. In this embodiment, a variety of joints and bones are identified: each hand 302, each forearm 304, each elbow 306, each bicep 308, each shoulder 310, each hip 312, each thigh 314, each knee 316, each foreleg 318, each foot 320, the head 322, the torso 324, the top 326 and the bottom 328 of the spine, and the waist 330. Where more points are tracked, additional features may be identified, such as the bones and joints of the fingers or toes, or individual features of the face, such as the nose and eyes.

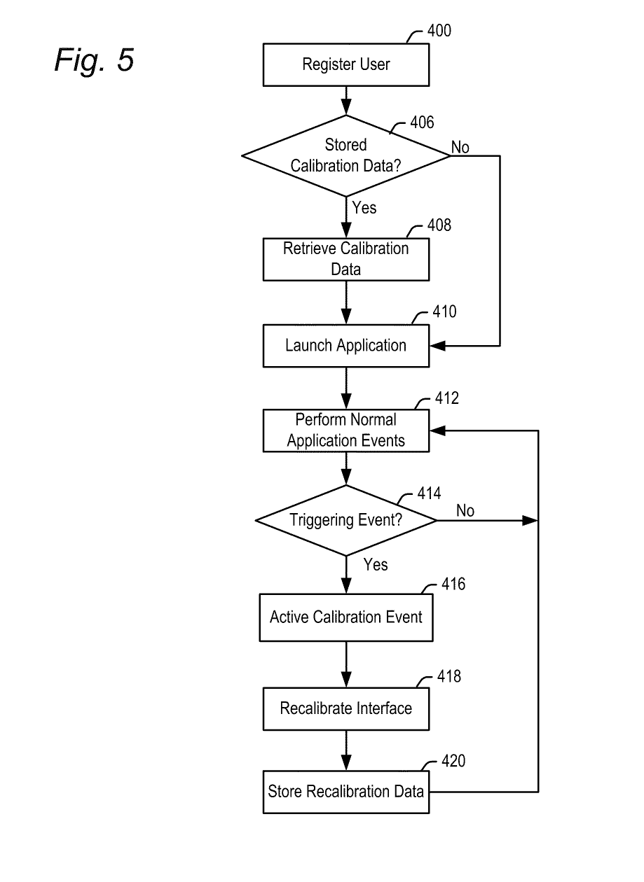

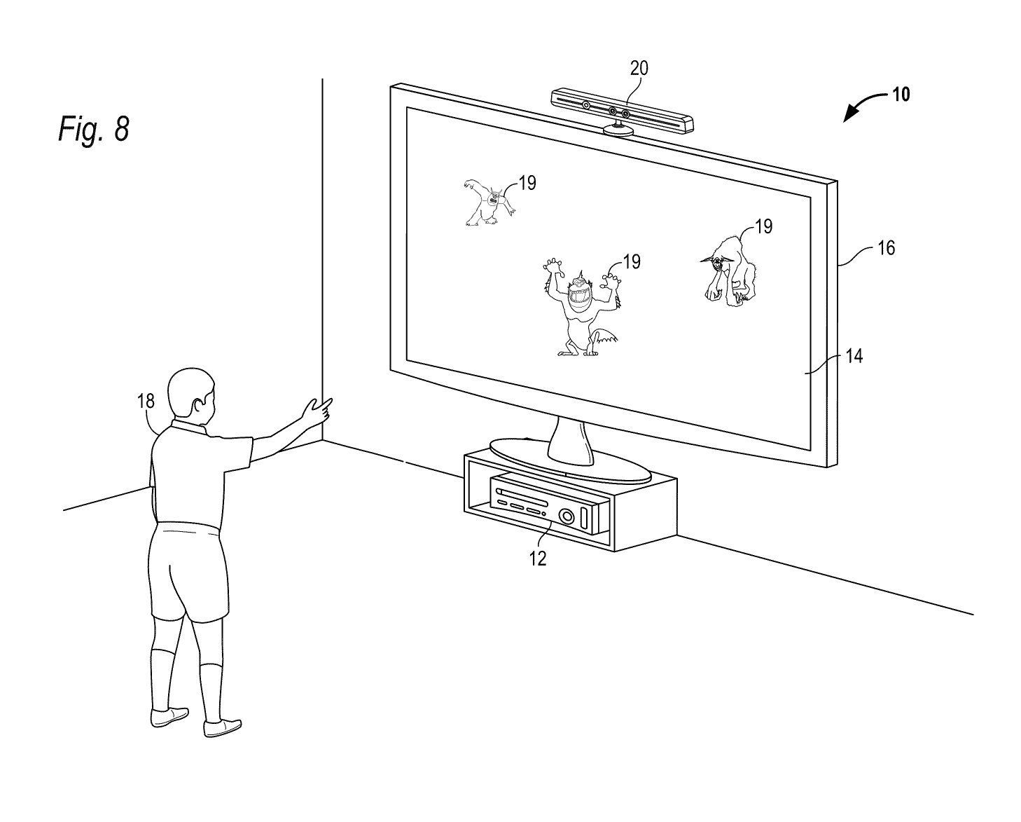

Aspects of the present technology will now be explained with reference to the flowcharts of FIGS. 5-7 and the illustrations of FIGS. 8-12. In step 400, the computing environment 12 registers a user appearing in front of the capture device 20. The registration may be performed by a variety of registration algorithms running on the computing environment 12, including for example a user logging in, positively identifying himself or herself to the system, or the computing environment recognizing the user from his or her image and/or voice. The registration step 400 may be skipped in alternative embodiments of the present technology.

This user may have interacted with a system 10 in the past. If so, calibration data may have been captured from these prior interaction sessions and stored as explained below. The calibration data may be stored in memory associated with the system 10 and/or remotely in a central storage location accessible by a network connection between the central storage location and the system 10. In step 406, the registration algorithm can check whether there is any stored calibration data for the registered user. If so, the calibration data for that user is retrieved in step 408. If there is no stored calibration data, step 408 is skipped. Steps 406 and 408 may be omitted in further embodiments.

In the event the calibration data was stored remotely in a central storage location, a user may obtain the calibration data using their own system 10 (i.e., the one previously used to generate and store calibration data), or another system 10 which they have not previously used. One advantage to having stored calibration data is that the system may automatically calibrate the interface to that user once the user begins use of a system 10, and no separate, initial calibration routine is needed. Even if there is no stored calibration data, the present technology allows omission of a separate, initial calibration routine, as calibration is performed “on the fly” in active calibration events as explained below. Although the present technology allows omission of a separate, initial calibration routine, it is conceivable that initial calibration data be obtained from a separate, initial calibration routine in further embodiments.

In step 410, a user may launch an application over the computing environment 12. The application, referred to herein as the NUI application, may be a gaming application or other application where the user interface by which the user interacts with the application is the user himself moving in the space in front of the capture device 20. The capture device captures and interprets the movements as explained above. In the following description, a user's hand is described as the user interface (UI) pointer which controls the NUI application. However, it is understood that other body parts, including feet, legs, arms and/or head may also or alternatively be the UI pointer in further examples.

FIG. 8 is one example of a user interacting with a NUI application. In this example, the NUI application is a shooting game where the user points his arm at the screen and moves it around in an X, Y plane to aim at objects 19 appearing on the display 14. The user may then cause a virtual gun to fire in the direction the user is aimed at, for example by moving his hand closer to the screen in the Z-direction. This example is used to illustrate inventive aspects of the present technology. Given the description above and which follows, those of skill in the art will appreciate a wide variety of other NUI applications into which the present technology may be incorporated to provide active calibration. Moreover, as explained below, once calibration is performed in a first application, that calibration may be used for interactions of the user with other NUI applications.

In the example shown in FIG. 8, the object of the gaming application is for the user to shoot and hit objects 19, which move around the screen. Thus, the user moves his arm around to properly aim at an object 19 at which the user 18 wishes to shoot. Hitting an object 19 may augment the user's score, while missing does not. As discussed above, over time, the user's movements to aim the gun at a given 2-D screen location may change. The user may get tired, in which case the user may tend to move his or her arm less to hit an object at a given position on the display than when the user started. Alternatively, the user may get excited, in which case the user may tend to move his or her arm more to hit an object at a given position on the display. A variety of other factors may alter the user's movements and/or position with respect to the user interface. Accordingly, the active calibration events of the present technology may periodically recalibrate the user interface so that the user may hit targets and otherwise interact with the user interface in a consistent manner throughout the user session, thereby improving the user experience.

In step 412, the NUI application runs normally, i.e., it runs according to its intended purpose without active calibration events. In step 414, the NUI application looks for a triggering event. If found, the NUI application performs an active calibration event as explained below. A triggering event may be a wide variety of different events. In embodiments, it may simply be a countdown of a system clock so that the triggering event automatically occurs every preset period of time. This period of time may vary in different embodiments, but may for example be every minute, two minutes, five minutes, etc. The countdown period may be shorter or longer than these examples. Thus, where the countdown period is one minute, once every minute the user is running the NUI application, the triggering event will happen and the active calibration event will occur.

The triggering event may be events other than a countdown in further embodiments. In one such embodiment, the NUI application or other algorithm running on computing environment 12 may monitor success versus failure with respect to how often the user successfully selects or connects with an intended object, e.g., a object 19, on display 14 during normal game play. “Connects” in this context refers to a user successfully orienting his or her UI pointer, such as his hand, in 3-D space so as to accurately align with the 2-D screen location of an object on the display Thus, in the example of FIG. 8, the system may monitor that a user successfully aims his or her hand at an object 90% of the time over a first period of time. However, at some point during the user interaction with the NUI application, the system notes a drop in the percentage that a user successfully connects with an object 19 over a second period of time. Where the drop in percentage exceeds some threshold over a predefined period of time, this may be considered a triggering event in step 414 so as to trigger the active calibration.

Those of skill in the art will appreciate that the above embodiment may be tuned with a wide variety of criteria, including what percentage drop to be used for the threshold, and for how long this percentage drop needs to be seen. As one of many examples, the system may establish the baseline success rate over a first time period of five minutes. If, after that period, the system detects a drop in successful connections by, for example, 10% over a period of one minute, this may trigger the calibration step. The percentage drop and the time period over which it is seen may both vary above or below the example values set forth above in further embodiments. Other types of events are contemplated for triggering the need for the active calibration step.

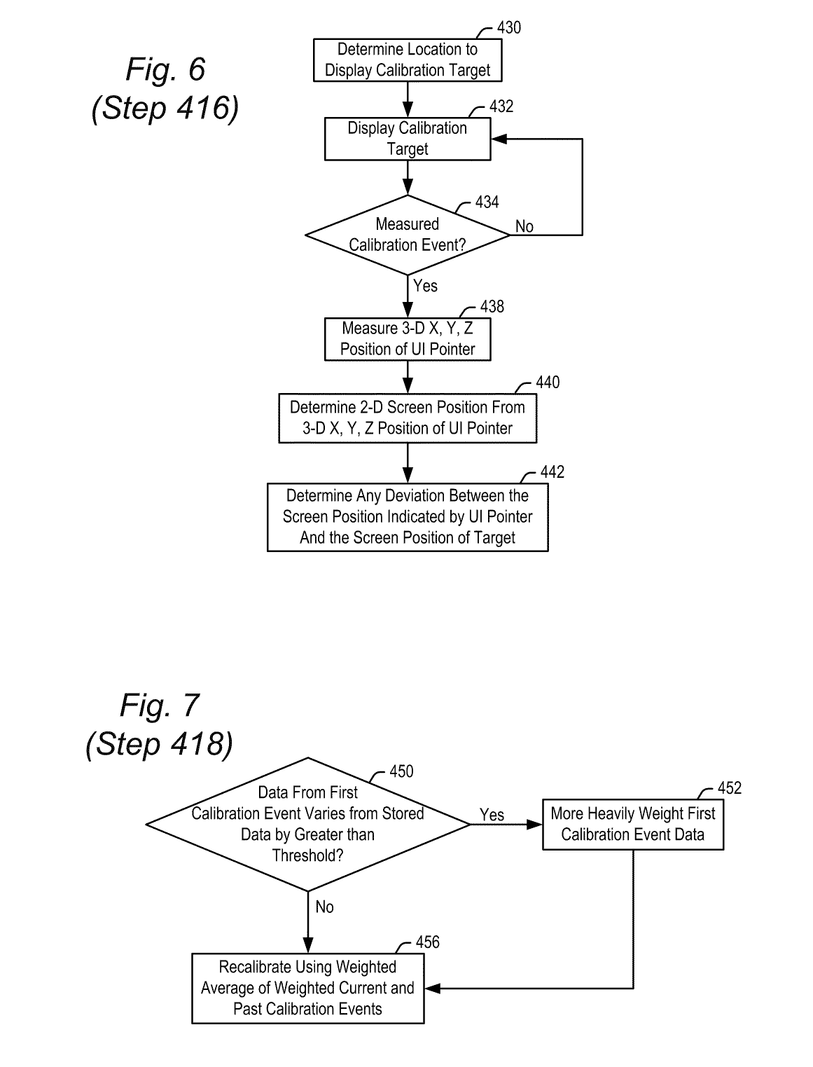

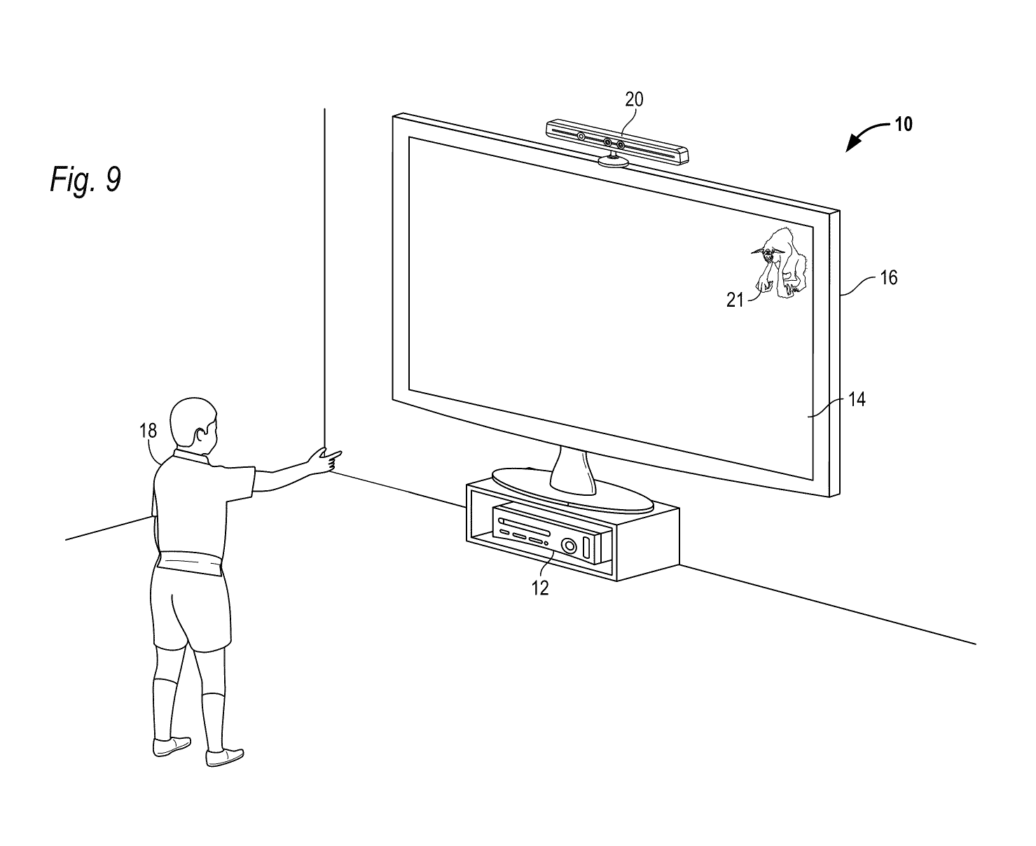

If no trigger event is detected in step 414, the NUI application performs its normal operations. However, if a trigger event is detected, the NUI application performs an active calibration event in step 416. Further details of the active calibration step 416 are described below with respect to the flowchart of FIG. 6 and the illustrations of FIGS. 9-12.

In general, the calibration event includes the steps of putting up a target object (e.g., target object 21, FIGS. 9-12) on the screen, and calibrating the user's movements so that the 2-D screen position indicated by the 3-D position of the UI pointer is adjusted to the 2-D screen position of the target object. In a first step 430, the NUI application determines where to display the target object. In particular, the NUI application may place the target object at different places in different active calibration events so as to get a full picture of how the user moves to select or connect with different objects across the display. The prior locations where the targets 21 were displayed may be stored, so that the target 21 is placed in different locations in successive active calibration events. The target may be placed in the same location in successive active calibration events in alternative embodiments.

The target is displayed in step 432. FIGS. 9-12 show four different locations of where a target 21 may be displayed on the screen in four different active calibration events. The four different positions correspond to the four corners of the display 14. The assumption is that any limitations in the user's ability to point to objects on the display will be detected by placing the targets in the corners in different active calibration events. However, it is understood that the target need not be placed in a corner in a given active calibration event, and need not be placed in the corners in any active calibration event, in further embodiments. Only a single target 21 may be shown on the display during an active calibration event so that there is no discrepancy as to which object the user is pointing at. However, there may be more than one target 21 on the display during an active calibration event in further embodiments.

As shown in FIGS. 8-12, the target object 21 may have the same appearance as an object 19 presented as part of the normal game operation. Thus, in embodiments, calibration events may be seamlessly integrated into a NUI application, and presented in such a way so that a user may not be able to distinguish a calibration event from normal interaction events. In further embodiments, the target object 21 may have a different appearance than objects 19 presented during normal operation of a NUI application. Similarly, an object 21 may have the same appearance as one or more normal operation objects 19, but a user may still be able to identify when a calibration event is being presented.

Once a target object 21 is displayed, the system detects a user's movement in step 434 to point to or connect with the target object 21. If the system does not detect a calibration event in step 434 of the user moving to select a target object, the system may return to step 432 to display another target object 21.

Assuming the user moves to point at the target object, the system measures the X, Y and Z position of the UI pointer (the user's hand in this example) in 3-D space in step 438. The system may make separate, independent measurements of X, Y and Z positions, and may recalibrate X, Y and Z positions independently of each other. Assuming a reference system where X direction is horizontal, Y direction is vertical and Z is toward and away from the capture device 20, the greatest deviation in movement may occur along the Y axis due to gravity-driven fatigue. This may not be the case in further examples.

Calibration of movements along the Z-axis may present a special case, in that these movements often represent a control action rather than translating to pure positional movement in 2-D screen space. For example, in the shooting embodiment of FIG. 8, a movement in the Z-direction triggers firing of the virtual gun. These Z-motions need not be calibrated in the same way that X and Y motions are calibrated by the active calibration events (though they may be calibrated in some manner during the active calibration events as well). On the other hand, some Z-movements do represent movement in the 2-D dimensional screen space. For example, in the boxing embodiment of FIGS. 1A and 1B, a thrown punch may land short if a user does not move his or her hand sufficiently in the Z-direction. In embodiments where a movement in the Z-direction in 3-D real world space translates into a movement in the Z-direction in 2-D screen space (in a virtual dimension into the screen), this may be calibrated by the active calibration steps described above and hereinafter. It is understood that Z-direction control movements (such as in the shooting embodiment of FIG. 8) may also be calibrated by the active calibration steps described herein.

Once the system measures the X, Y and Z position of the UI pointer in 3-D space, the system maps this to the corresponding position of the UI pointer in 2-D screen space in step 440. This determination may be made one of two ways. It may be the actual 2-D position indicated by the 3-D world position of the UI pointer (i.e., without any calibration adjustment), or it may be the actual 2-D position adjusted based on a prior recalibration of the UI pointer to screen objects.

In step 442, the system determines any deviation between the 2-D position of the target and the determined 2-D position corresponding to the 3-D position of the UI pointer. This deviation represents the amount by which the system may recalibrate so that the 2-D position determined in step 440 matches the 2-D position of the target 21. As explained below with respect to the recalibration step, the amount of the recalibration that is performed may be less than indicated by step 442 in embodiments.

Returning to the flowchart of FIG. 5, after the calibration event is performed in step 416, the system may recalibrate the user interface in step 418 so that the user's motion better tracks to objects on the display. This recalibration may be performed in a number of ways. As noted above, the user interface maps a position of the 3-D UI pointer to a 2-D position on the display. In a straightforward embodiment, the system recalibrates the interface based solely on the deviation of step 440 between this determined 2-D position and the 2-D position of the target 21. Stated another way, the system adjusts the mapping of the 2-D screen position of the 3-D UI pointer to match the position of the target 21. Thus, the amount of correction is the entire deviation determined in step 440.

In further embodiments, instead of the most recent deviation being used as the sole correction factor, the system may average the most recent deviation together with prior determined deviations from prior active calibration events. In this example, the system may weight the data from the active calibration events (current and past) the same or differently. This process is explained in greater detail with respect to the flowchart of FIG. 7.

As indicated, in embodiments, the recalibration step 418 may be performed by averaging weighted values for the current and past calibration events. The past calibration events are received from memory as explained below. If the user is using the same system in the same manner as in prior sessions, the past calibration events may be weighted the same or similarly to the current calibration event. The weighting assigned to the different calibration events (current and past) may be different in further embodiments. In embodiments where weights are different, the data for the current calibration event may be weighted higher than stored data for past calibration events. And of the stored values, the data for the more recent stored calibration events may be weighted more than the data for the older stored calibration events. The weighting may be tuned differently in further embodiments.

It may happen that some aspect has changed with respect to how the user is interacting with the system 10 in the current session in comparison to past sessions. It could be that an injury or other factor is limiting the user's movement and ability to interact with the system. It could be that a user wore flat shoes during prior sessions and is now wearing high heels. It could be that the user stood in prior sessions and is now seated. It could also be that the user is interacting with a new display 14 that is larger or smaller than the user is accustomed to. It could be a wide variety of other changes. Each of these changes may cause the X and/or Y position (and possibly the Z position) to change with respect to the capture device 20 in comparison to prior sessions.

Thus, in the embodiment described with respect to FIG. 7, the system first checks in step 450 whether the data from the initial active calibration event varies above some predefined threshold from the data of past active calibration events that were retrieved from memory. If so, the system assumes that some condition has changed, and the system more heavily weights the initial active calibration event in step 452 in comparison to past active calibration events. In embodiments, this heavier weighting may mean to disregard all prior data of calibration events and merely use the current active calibration event data. In further embodiments, this heavier weighting may be some predefined addition to the weight of the current calibration event data relative to past calibration event data. The threshold change which triggers step 450 may vary in different embodiments, but as merely one example, if the initial calibration shows a deviation in the X direction, Y direction and/or Z direction of more than 10% to 20% in comparison to the stored data, step 450 may trigger the additional weight to the current active calibration in step 452.

Whether weighting per some predetermined scheme, or skewing the weight of the current active calibration event data more heavily in step 452, the system uses the weighted average of the current and stored active calibration events in step 456 to determine the recalibration of the interface. Thus, in an example, the interface may be recalibrated only a portion of the total current deviation between the most recent determined 2-D position at which the user is pointing and the position of the target object 21. Or the interface may be recalibrated an amount greater than the current measured deviation. The number of past calibration events which may play into the recalibration of the interface may be limited to some number of most recently stored active calibration events, such as for example using only the most recent five to ten active calibration events. The number used may be more or less than that in further embodiments.

As indicated above, the system may alternatively simply use the most current active calibration event for recalibration purposes. In this event, the system may recalibrate the entire amount of the deviation between the current determined 2-D position at which the user is pointing and the position of the target object 21, and use that as the sole basis for the correction. In such an embodiment, the steps shown in FIG. 7 may be omitted.

Referring again to the flowchart of FIG. 5, after the interface has been recalibrated as described above in step 418, the system may store the data from the current recalibration event in step 420. As noted, this data may be stored locally. In such an event, the data may be used in later recalibrations of the interface within the same NUI application. Moreover, where a user switches to a new NUI application, the calibration event data obtained in the earlier NUI application may be used in the new NUI application for recalibrating the interface. As one example, the NUI application the user first plays may be the boxing game shown in FIGS. 1A and 1B. In this example, the user may be presented with an active calibration event at the start of each boxing round. As one example, the user may be prompted to strike a bell to indicate the start of the round. That bell may be the target object 21 and located in different positions, such as those shown by the target objects in FIGS. 9-12. Depending on how close the user comes to connecting with the bell, the NUI application may recalibrate the interface as described above to better enable the user to hit his boxing opponent during the round.

However, upon completion of the boxing game, the user may choose to play the shooting game of FIG. 8. The user may be periodically presented with new calibration events as shown in FIGS. 9-12 and as described above. However, the data from the calibration events in the boxing game may also be used in the shooting game, and play into the weighted average when determining how to recalibrate the interface during the shooting game.

In addition to storing calibration event data locally, the determined calibration event data may be stored remotely in a central storage location. Such an embodiment may operate as described above, but may have the further added advantage that stored calibration event data may be used for recalibration purposes when the user is interacting with a different system 10 than that which generated the stored calibration event data. Thus, as an example, a user may play a game at a friend's house, and the system would automatically calibrate the interface to that particular user when the user first starts playing, even if the user has never played at that system before. Further details relating to the remote storing of data and use of that data on other systems is disclosed for example in U.S. patent application Ser. No. 12/581,443 entitled “Gesture Personalization and Profile Roaming,” filed on Oct. 19, 2009, which application is assigned to the owner of the current application and which application is incorporated herein by reference in its entirety.

In embodiments, the active calibration routine is built into the NUI application developed for use on system 10. In further embodiments, portions or all of the active calibration routine may be run from a system or other file in the computing environment 12 operating system, or some other algorithm running on computing environment 12 which is separate and distinct from the NUI application into which the active calibration events are inserted.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. In a system comprising a computing environment coupled to a capture device for capturing user motion and a display for displaying objects, a method of active calibration of a user interface for a user to interact with objects on the display, comprising:
a) running an application on the computing environment;
b) receiving input for interacting with the application via the user interface;
c) periodically performing an active calibration of the user interface while running the application in said step a); and
d) recalibrating the user interface based at least in part on the active calibration performed in said step c).

2. The method of claim 1, said step of periodically performing an active calibration comprising the steps of:
e) displaying a target object on the display;
f) measuring the user's position to contact the target object via the user interface;
g) determining a 2-D screen position corresponding to the user's position measured in said step f); and
h) determining a disparity between the 2-D screen position determined in said step g) and the 2-D screen position of the target object displayed in said step e).

3. The method of claim 2, said step d) of recalibrating the user interface based on the active calibration comprising the step of recalibrating the user interface the entire amount of the disparity determined in said step h).

4. The method of claim 2, said step d) of recalibrating the user interface based on the active calibration comprising the step of recalibrating the user interface based on the disparity determined in said step h) averaged together with disparities determined from prior active calibrations of the user interface.

5. The method of claim 4, wherein the disparity of said step h) weighs greater in the average than disparities determined from prior active calibrations of the interface.

6. The method of claim 1, said step of periodically performing an active calibration being triggered by elapse of a predefined time period.

7. The method of claim 1, said step of periodically performing an active calibration being triggered by a detected change in the user's interaction with the user interface.

8. The method of claim 1, said step d) performed while the application is running on the computing environment in said step a).

9. The method of claim 8, the application comprising a first application, said step d) further performed while a second application is running on the computing environment, the second application being different than the first application.

10. The method of claim 1, further comprising the step j) of storing data relating to the active calibration on a storage system associated with the computing environment or accessible by the computing environment via a network connection.

11. In a system comprising a computing environment coupled to a capture device for capturing user motion and a display for displaying objects, a method of active calibration of a user interface for a user to interact with objects on the display, comprising:
a) providing the user interface, the user interface mapping a position of user interface pointer in 3-D space to a 2-D position on the display;
b) displaying a target object on the display;
c) detecting an attempt to select the target object on the display via the user interface and user interface pointer;
d) measuring a 3-D position of the user interface pointer in selecting the target object user interface;
e) determining a 2-D screen position corresponding to the user's position measured in said step d);
f) determining a disparity between the 2-D screen position determined in said step e) and the 2-D screen position of the target object displayed in said step b); and
g) periodically repeating said steps b) through f).

12. The method of claim 11, further comprising the step h) of recalibrating the user interface based at least in part on the disparity determined in said step f).

13. The method of claim 12, further comprising the step j) of recalibrating the user interface based on multiple disparities determined between the 2-D screen position and the 2-D screen position of the target object in periodically repeating said steps b) through f).

14. The method of claim 11, said step of periodically repeating said steps b) through f) being triggered by elapse of a predefined time period.

15. A system, comprising:
a capture device for capturing position data relating to objects in a field of view of the capture device;
a display;
a computing environment for receiving image data from the capture device and for running an application; and
a user interface controlled by the computing environment and operating by mapping a position of a pointing object of the objects in the field of view to a position of an object displayed on the display, the computing environment periodically recalibrating the mapping of the user interface while the computing environment is running the application.

16. The system of claim 15, the application comprising a first application, the computing environment capable of running a second application different than the first application, the second application using the recalibrated mapping of the user interface determined by the computing environment while the first application was running.

17. The system of claim 16, the computing environment further periodically recalibrating the mapping of the user interface while the computing environment is running the second application.

18. The system of claim 15, further comprising a storage location as part of the computing environment or remote from the computing environment and accessible by the computing environment by a network connection, the storage location storing the data generated by the periodic recalibration of the mapping of the user interface.

19. The system of claim 18, the computing environment retrieving data from the storage location for use in recalibrating the user interface.

20. The system of claim 18, the computing environment and the user interface comprising a first computing environment and a first user interface, and the storage location being remote from the computing environment, the system further comprising a second computing environment and a second user interface, the second computing environment periodically recalibrating the mapping of the second user interface at least in part based on the data stored in the storage location, the data generated by the periodic recalibration of the mapping of the first user interface by the first computing environment.
